(19) United States
(12) Patent Application Publication
(10) Pub. No.: US 2014/0082693 A1
(43) Pub. Date: Mar. 20, 2014

(54) UPDATING SECURITY BINDINGS IN A NETWORK DEVICE

(71) Applicants: Shaun Wackerly, Lincoln, CA (US); Jeremy Brown, Roseville, CA (US)

(72) Inventors: Shaun Wackerly, Lincoln, CA (US); Jeremy Brown, Roseville, CA (US)

(21) Appl. No.: 13/620,255

(22) Filed: Sep. 14, 2012

(51) Int. Cl. G06F 21/00

(52) U.S. Cl. 726/3

(57) ABSTRACT

A network device includes a security binding table. The network device is configured to couple to a network and configured to receive security information from a source device. A processor is included to compare the lookup portion of the received security information from the source device to the lookup portion of each entry of the security binding table and to compare the match portion of the received security information from the source device to the match portion of each entry of the security binding table to determine if there is a match, and to update the security binding table by adding an entry comprising the lookup portion and the match portion of the received security information from the source device when neither the lookup portion nor the match portion of the received security information from the source device matches any entry of the security binding table.

### BACKGROUND

Security bindings are often used in static networks to prevent disallowed hosts from disrupting a network. In many present dynamic network environments, security bindings are controlled and tracked by a network administer. Tracking and administering security bindings can be challenging in large network environments and where not all parts of the network are controlled or administered by the same entity.

### BRIEF DESCRIPTION OF THE DRAWINGS

FIG. 1 is a computer network in accordance with one embodiment.

FIG. 2 is a network device in accordance with one embodiment.

FIGS. 3A and 3B illustrate security bindings for a network in accordance with one embodiment.

FIG. 4 is a flow diagram illustrating a method of updating a network device in accordance with one embodiment.

FIG. 5 is a flow diagram illustrating a method of updating a network device in accordance with one embodiment.

FIG. 6 is a flow diagram illustrating a method of updating a network device in accordance with one embodiment.

### DETAILED DESCRIPTION

In the following detailed description, reference is made to the accompanying drawings which form a part hereof, and in which is shown by way of illustration specific embodiments in which the invention may be practiced. In this regard, directional terminology, such as “top,” “bottom,” “front,” “back,” “leading,” “trailing,” etc., is used with reference to the orientation of the Figure(s) being described. Because components of embodiments can be positioned in a number of different orientations, the directional terminology is used for purposes of illustration and is in no way limiting. It is to be understood that other embodiments may be utilized and structural or logical changes may be made without departing from the scope of the present invention. The following detailed description, therefore, is not to be taken in a limiting sense, and the scope of the present invention is defined by the appended claims. It is to be understood that features of the various embodiments described herein may be combined with each other, unless specifically noted otherwise.

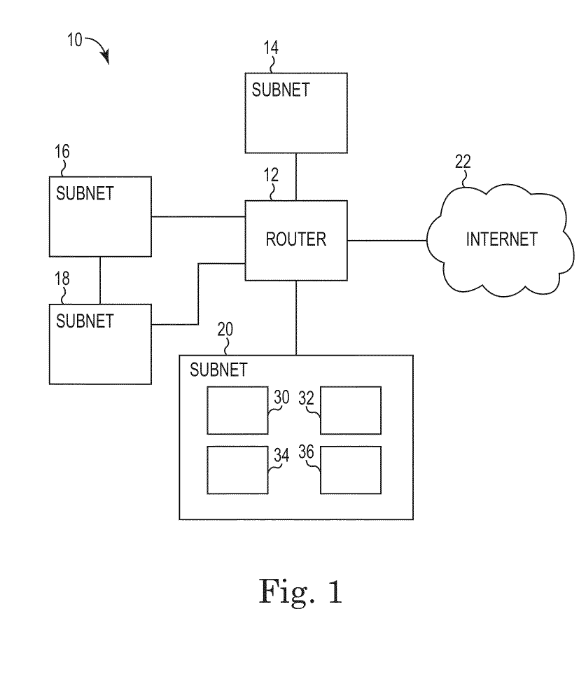

FIG. 1 illustrates computer network 10 in accordance with one example. Computer network 10 includes router 12, first through fourth subnets 14, 16, 18 and 20, and internet 22. Router 12 is coupled to internet 22 and coupled to each of first through fourth subnets is 14, 16, 18 and 20.

In one example, computer network 10 illustrates a network identified and discussed generally in the International Standards Organization, standard ISO/IEC 7498, which defines a 7-layer model for describing interconnected systems. It is referred to the Open Systems Interconnection (OSI) model and is incorporated herein by reference in its entirety.

Computer network 10 includes layer 1 of the OSI networking protocols, which is a physical layer that describes the actual physical elements, such as cables and connectors, which connect different devices of a computer network. Each of first through fourth subnets 14, 16, 18 and 20 can each contain a number of layer 2 devices, such as switching devices. Although network 10 is illustrated in one example as having first through fourth subnets 14, 16, 18, 20, more or less subnets can be used as well. Also, although illustrated as connected to internet 22, network 10 can in some instances be a private network that is not connected to the internet.

For example, fourth subnet 20 is illustrated including first through fourth network devices 30, 32, 34 and 36. In one example, first through fourth network devices 30, 32, 34 and 36 are layer 2 devices, such as switches or hubs. First through third subnets 14, 16 and 18 similarly include layer 2 devices, but are not specifically illustrated for ease of description.

Throughout this description, features are explained and examples are given with reference to network device 30, which is an OSI layer 2 device that communicates with other devices over an OSI layer 1 computer network 10.

These described features and examples, however, are applicable at any OSI layer, depending on where matching and network security are applied. For instance, the network security can be checking MAC address (OSI layer 2), IP address (OSI layer 3), TCP/UDP port number (OSI layer 4), or any other individual attribute (OSI layer 1-7), or even a combination of attributes from multiple layers (like IP & MAC)

Each of first through fourth network devices 30 through 36 have a number of ports to which additional switches can be coupled, or to which host devices such as end user computers, or servers, or mainframes can be connected. At the level of first through fourth subnets 14, 16, 18 and 20, different devices are connected to the subnet and can communicate with other devices on the subnet by transmitting data packets through the switches. Generally, a host that sends a data packet is referred to as a source device and the host that is the intended recipient of the data packet is referred to as the destination device.

These data packets include layer 2 addresses, such as a MAC address, for the device to which the data packet is to be sent (layer 2 destination address), and the layer 2 address, such as the MAC address, for the host which is sending the packet (layer 2 source address). The source and destination layer 2 addresses identify the devices sending and receiving the data packet and the MAC address is a unique address that corresponds to a device connected on a network.

In addition, each host device will be assigned a layer 3 address, such as an IP address. The IP address is, in one example, assigned using the Dynamic Host Configuration Protocol (DHCP). Each host on a subnet will normally be assigned a layer 3 address. In one example, data packets generated by a host on a subnet can include information that is being sent from one host to another host, and further these data packets will include layer 2 addresses, such as MAC addresses as described above, and source and destination layer 3 addresses, such as a source IP address and a destination IP address. The layer 3 address is utilized by router 12 to determine routing for data packets which are being sent by a host (source device) on one subnet to a host (destination device) on a different subnet, or to a different device which may require that the data packet be transmitted via internet 22.

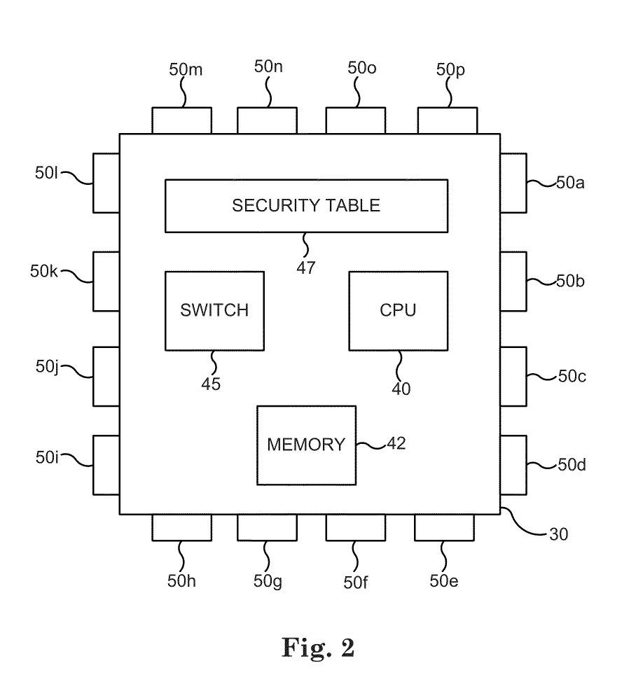

FIG. 2 illustrates network device 30 in accordance with one example. In one example, network device 30 includes CPU 40, memory 42, switch 45, security table 47 and ports 50A through 50P. In one example, network device 30 provides layer 2 switching functionality where the layer 2 addresses of different host devices coupled to the subnet are utilized in applying switching procedures and identifying different host devices on the subnet, such as first through fourth subnets 14 through 20 in FIG. 1. End user host devices, such as personal computers, can be coupled to any of ports 50A through 50P. Furthermore, other network devices such as hubs or additional switches can be connected to a port of network device 30.

Fourth subnet 20 in FIG. 1 includes first through fourth network devices 30, 32, 34 and 36 for illustration purposes, but in other examples could include one network device 30, and in yet another include a large number of network devices coupled together and connected with a large number of hosts to form a large subnet.

In operation, network device 30 allows for passing data packets received from a source device on one of ports 50A through 50P through the network device switch 45 and then transmitting the received data packets through a different one of ports 50A through 50P, such that the data packet is transmitted to an intended destination device. In one example, CPU 40 operates to control the switch 45 and control the data transmission controlling the operation of memory 42, switch 45 and security table 47. In one example, security table 47 is managed and populated by CPU 40, and in another security table 47 is embedded in the application-specific integrated circuits of network device 30. Network device 30 includes security table 47, which in one example, is accessible to a network administrator, and in conjunction with CPU 40, controls and administers computer network 10. In one example, CPU 40 utilizes security table 47 and the security bindings therein to prevent disallowed host devices from disrupting a network.

Security bindings are sometimes used in static networks to prevent disallowed or attacker hosts from disrupting a network. In such case, when an administrator builds network 10, the network administrator builds a list or table that includes security information, such as the address and location, for each network infrastructure device. These security binding tables are then entered into a security framework manually (static bindings), which is very time-consuming. The security bindings are illustrated by security table 47, which is a layer 2 device, in the examples below, but can also be extrapolated to any of the seven OSI layers.

In one example, security table 47 is configured with security binding table built by the network administrator, sometimes referred to as a white list. The white list is a security binding table that contains a list of entries identifying security information for approved hosts. A host device is then permitted (approved) only if its information is found as an entry in the white list of security table 47. If a host device is not found in the list, then it is implicitly considered to be disapproved. In another example, the lookup table built by the network administrator is a black list, such that a host device is permitted (approved) only if it is NOT found in the black list. The black list is a security binding that contains a list of entries identifying disapproved hosts. If a host device is not found in the list, then it is implicitly considered to be approved.

In one example, entries in a security binding table are made up of a lookup portion and a match portion. The lookup portion allows, for example, a data packet to be matched with a specific binding, and the match portion determines whether or not the data packet matches the entire security binding. In one example, a security binding lookup is the source device layer 2 address, such as a source MAC address, and the match portion is the source device layer 3 address, such as a source IP address and source port. Although layer 2 and layer 3 addresses are used to illustrate example security bindings below, any of a variety of parameters can be used in security bindings, such as layer 4 addresses or any of a variety of unique characteristics by which host device traffic is identified in any of the OSI layers 2-7. Essentially, any of the addressing information for OSI layers 2-7 can be used as the lookup and match portions of the security bindings.

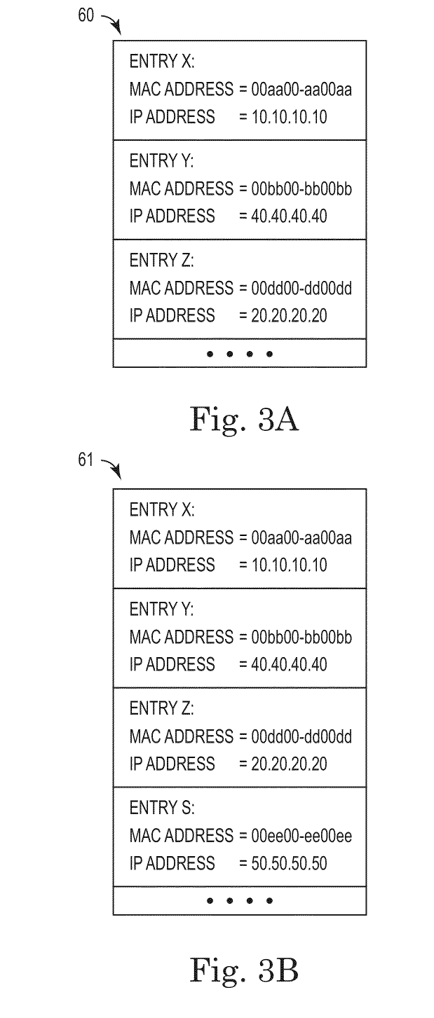

FIG. 3A illustrates a portion of a white list 60, which is a security binding table that is from a network security framework, such as resident in security table 47. The illustrated list 60 includes entries X, Y and Z, each of which includes a lookup portion (which is illustrated in the example as a layer 2 MAC address) and a match potion (which is illustrated in the example as a layer 3 IP address). Entry X has a MAC address that is 00aa00-aa00aa and an IP address that is 10.10.10.10; Entry Y has a MAC address that is 00bb00-bb00bb and an IP address that is 40.40.40.40; and Entry Z has a MAC address that is 00dd00-dd00dd and an IP address that is 20.20.20.20.

As such, in operation, if a source host attempts to pass information through network device 30 that includes security table 47, CPU 40 will check the security information associated with the source host against the entries in white list 60 retained in security table 47 to determine whether the information from the source host will be switched through. In one example, white list 60 is also resident in other security tables of other network devices throughout computer network 10.

In one example using white list 60 illustrated in FIG. 3A, if source host A has associated security information of a MAC address that is 00aa00-aa00aa and an IP address that is 10.10.10.10, source host A would be permitted to pass the information, because CPU 40 would use the lookup portion to locate entry X (based on a MAC address) and the comparison of the IP addresses (match portions) would be successful. Source host B, however, with security information of a MAC address that is 00bb00-bb00bb and an IP address that is 20.20.20.20 would be blocked, because CPU 40 would use the lookup to find entry Y (based on MAC address), but the comparison of the IP addresses (match portions) would fail. Similarly, host C with security information of a MAC address that is 00cc00-cc00cc and an IP address that is 30.30.30.30 would also be blocked, because using the lookup, CPU 40 would not find any entry (based on MAC address) in white list 60 illustrated in FIG. 3A. The end result of a failed lookup and failed match are the same, the host would be blocked, such that any traffic sent by the blocked source device would not be forwarded to other hosts on network 10.

In one example, however, network device 30 includes security table 47 configured with sticky bindings. A sticky binding allows a source host, which has security information that does not match any entry existing in white list 60 of security table 47, to create a new security binding entry in white list 60 so that the host is not blocked. The new security binding is dynamically created to match the security information from the host. This security binding would then be enforced for subsequent information sent from the source host that is seen by the network infrastructure such that the source host is then explicitly allowed to send information to other hosts on network 10.

In one example, with a source host D with security information of a MAC address that is 00ee00-ee00ee and an IP address that is 50.50.50.50, CPU 40 would initially fail to find a lookup portion (based on a MAC address) when compared against the entries in the white list 60 illustrated in FIG. 3A. CPU 40 also would not have a successful comparison with any entry based on the match portion (IP address). Because security table 47 is configured with sticky bindings, however, CPU 40 would update security table 47 and white list 60 and create a new sticky binding entry S with a MAC address that is 00ee00-ee00ee and an IP address that is 50.50.50.50. Such an updated white list 61 is illustrated in FIG. 3B. As such, any subsequent information sent from source host D would be allowed because its security information is added to white list 60.

This would be true for all network devices configured with sticky bindings in the security table. In one example, all the network devices within computer network 10 that are configured with a security table having a security binding are also configured with a sticky binding such that information from a previously unknown source host, such as source host D, are allowed through these network devices once added to white list 60.

In one example, such updating of white list 60 occurred without a network administrator intervention. As such, if a new host, such as a new personal computer with a MAC address and IP address previously unknown to computer network 10 is subsequently added to computer network 10, its security binding can be added to the white list of the various security tables in the network and information from that added host is then allowed to be transmitted in the network without a network administrator having to be involved, thereby saving time and resources related to network administration.

In one example, sticky bindings are configured in security table 47 to be dynamically-learned only when neither the lookup portion nor the match portion of a host's security binding is found in white list 60. As such, a host such as host B, with its MAC address of 00bb00-bb00bb and IP address of 20.20.20.20 would not be added as a sticky binding, since its IP address actually matches Entry Z, which is already assigned to a different MAC address. In this case, security table 47 would assume that host B is an attacker that is spoofing an existing IP address, while using its own non-matching MAC address (20.20.20.20), and it would accordingly be blocked.

As may be evident, an attacker to network 10 using a MAC and IP address not matching any entry in a security binding can get allowed by virtue of the sticky binding. The attacker is not, however, allowed to change the information used to communicate. In other words, the attacker could not change its network “identity” (MAC address) and would therefore effectively be communicating as itself and would not spoofing someone on the network, thereby exposing itself to relatively easy detection by the network administrator.

Also, additional limitations can be set on the use of sticky bindings in a security table such as security table 47. In one example, the use of sticky bindings is enabled only during a time when the network is in a state that is known to be stable. For example, sticky bindings are only enabled during business hours or even only during a subset of business hours, during a time when it is more likely that users of a network are more likely to add or move a computer or other network device on the network 10.

Also, in one example, sticky bindings are enabled only based on certain criteria in the data packet. In one example, only a certain TCP/UDP protocol is allowed to be added by sticky binding. In another example, only a certain IP address range is allowed to be added by sticky binding. In another example, only a certain ingress port is allowed to be added by sticky binding.

In addition, the network administrator can employ other or additional methods for mitigating risks of attackers taking advantage of sticky bindings. For example, security table 47 can be configured to notify a network administrator when a new sticky binding is created. The administrator can also control and limit the number of dynamically-learned sticky bindings to some localized or global number of bindings, or even limit the number that can be created over a certain period of time or within a pool of IP addresses. This flexibility allows the network administrator to choose which portions of the network that are manually bound (static bindings), and which portions of the network that are learned and then bound (sticky bindings).

Accordingly, the amount of work a network administrator needs to spend to implement a security binding solution is reduced with the use of sticky bindings. The reduced workload makes it more likely that such a binding method would be employed as a method of enforcing security on network 10.

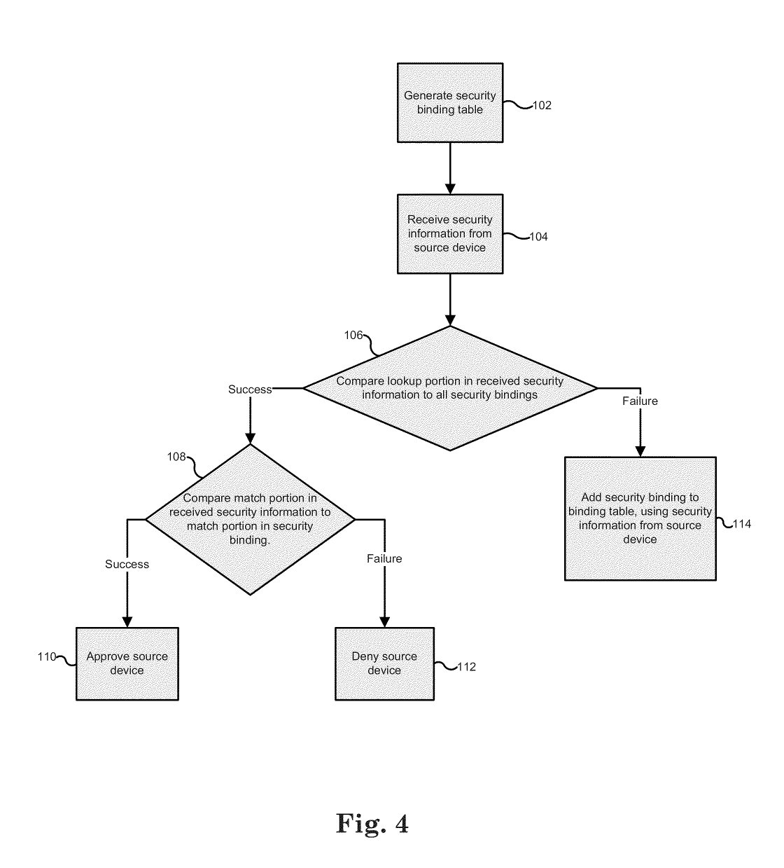

FIG. 4 is a flowchart illustrating one example of sticky bindings. At 102, a security binding table is generated, for example, in a security table of a network device. In one example, the security binding table includes entries each having a lookup portion and a match portion. At 104, security information is received from a source device. In one example, the received security information from the source device includes a lookup portion and a match portion. At 106, the lookup portion of the security information received from the source device is compared to the lookup portion of each entry of the security binding table. If the comparison of the lookup portions from the source device and the security binding table is successful, then at 108 the corresponding match portions of source device security information and the security binding table entry are compared. If the comparison at 108 of the match portions is successful, then at 110 the source device is confirmed as approved, such that data packets will be allowed from that source device. If the comparison at 108 of the match portions fails, then at 112, the source device is denied.

If the comparison at 106 between the lookup portions from the source device and the security binding table fails, then at 114, an entry is added to the security binding table as a sticky binding, using the security information from the source device.

In one example, security table 47 is further configured with polling updates to further dynamically correct or update security bindings in network 10. In one example, polling is implemented to auto-correct security bindings where some portion of the bound information has changed from when it was last stored. Polling retains the robustness of static bindings, but also gives the bindings enough flexibility to adapt to changing conditions.

For example, computer network 10 can be configured to be very large, where first through fourth subnets 14, 16, 18 and 20 are each located in geographically different areas and/or where multiple entities administer portions of the same network 10. For instance, two divisions in one same company each have their own networking administrator, one responsible for first subnet 14 and another for second subnet 16. If the networking administrator responsible for first subnet 14 reassigns security information of a network device within first subnet 14, this will affect the connectivity of the other subnets. Where security bindings are statically administered, there is a lot of manual coordination necessary between the two separate entities to prevent network outages.

When network devices in first through fourth subnets 14, 16, 18 and 20 include security ports configured with polling update capability, however, reassignments and adjustments of security information are accommodated dynamically with updated security bindings, and done without requiring intervention of network administrators.

In one example, proactive polling is implemented in security table 47. With proactive polling, CPU 40 polls all security bindings at a set time interval or triggered at a set event. As such, entries in white list 61 of the security binding table (illustrated in FIG. 3B) are polled periodically to determine whether the lookup and match portions of the bindings are still valid. In one example, a message is sent from security table 47 to each source device in the security binding table such that each such source device responds with its security information. If the security information of the source device matches the entry in the security binding table, the source device is approved. If there is not match, under certain circumstances, the entry is updated.

In one example, if an end user on network 10 changes its computer and couples in a new network device and uses its previous IP address, the MAC and IP addresses previously entered on white list 60 will no longer be valid. With proactive polling, however, the white list 60 is dynamically adjusted, within the parameters that have been established by the network administrator, so that all further information sent from this host will be allowed.

For example, if source host A, with associated security information of a MAC address that is 00aa00-aa00aa and an IP address that is 10.10.10.10, changes its device such that its new MAC address is 00ff00-ff00ff and retains its IP address, it no longer matches entry X in white list 60. With proactive polling, however, CPU 40 checks security table 47 and observes that the MAC address is changed, that this new MAC address is not in any entry of white list 60, and accordingly updates entry X to the new MAC address of 00ff00-ff00ff (leaving the IP address of 10.10.10.10). Accordingly, all further information from source host A will be allowed by security table 47.

The network administrator can set controls on proactive polling so that only certain targeted network devices are polled, only certain devices could be updated in the white list 60, or so that polling only occurs at certain times. In one example, if polling indicates that two different network devices are using a single IP address, the security binding will not be updated. Instead, CPU 40 and security table 47 assumes that the device with the MAC address matching that in white list 60 is valid and the other device with a non-matching MAC address is an attacker spoofing the IP address. In one example, polling reports the duplicate or attacker information to the network administrator or some security device.

In one example, only certain entries in the white list 60 of security bindings are polled in order to reduce a given set of security bindings based on criteria such as only a certain IP address range, only a certain set of source ports, or only sticky bindings. Since certain network devices, such as router 12 for example, would rarely ever change in network 10, these devices could be restricted from proactive polling in one example. Restricting the list of polled security bindings allows the network administrator to control the amount of flexibility and CPU overhead involved in polling security bindings.

In one example, when proactive polling is engaged, any bindings that fail to be validated through polling are identified to the network administrator as stale. As such, the administrator then has the option of updated the security bindings with new information or removing them to reclaim network binding resources.

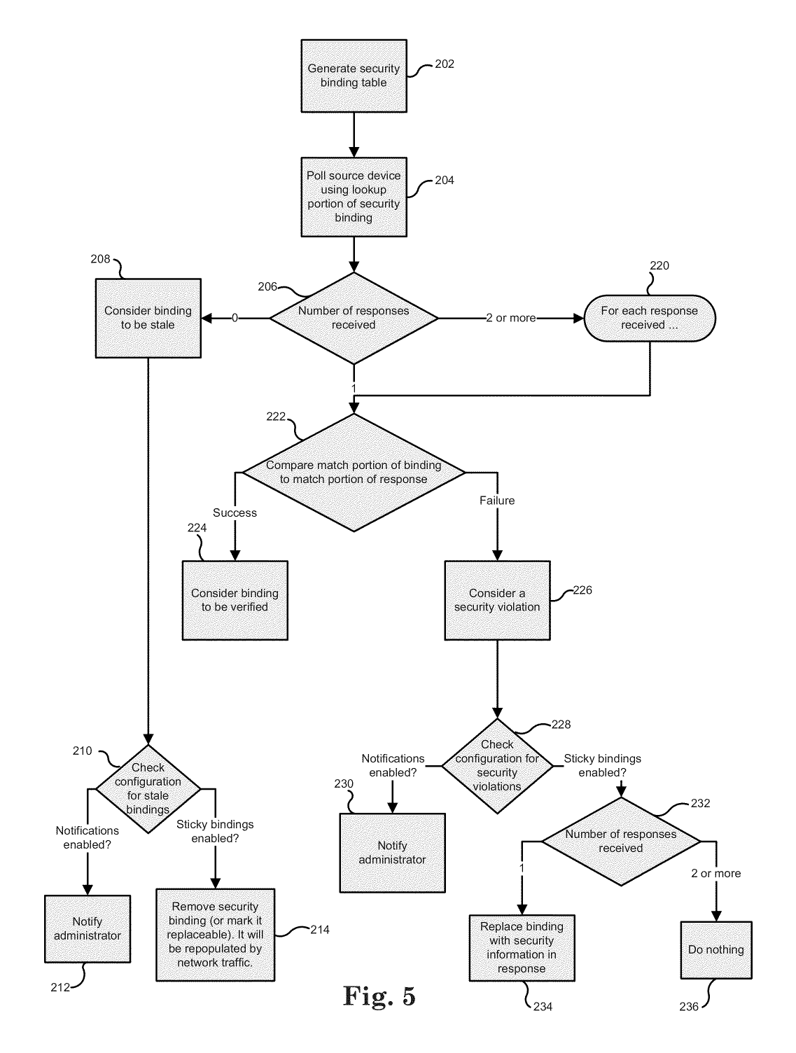

FIG. 5 is a flowchart illustrating one example of proactive polling. At 202, a security binding table is generated, for example, in a security table of a network device. In one example, each entry in the security binding table includes a lookup portion and match portion. At 204, the lookup portion of each entry in the security binding table is used to poll source devices. In one example, a polled source device will send back its security information, which includes a lookup portion and a match portion. At 206, any responses from the polling will be monitored and it will be determined how many are received.

If no responses are received from the polling, at 208 the binding used in the polling will be considered stale. When the lookup portion of an entry in the security binding that is used for polling a source device results in no response, it means that there has been a change to the source device corresponding to that entry. Based on the settings established by a network administrator, several options are available under this condition. At 210, the network configuration is checked for stale bindings. At 212, if notifications are enabled, the network administrator will be notified of the stale binding. At 214, if sticky bindings are not enabled, the security binding will be removed or marked as replaceable, so it can be repopulated by network traffic.

If two or more responses are received at 206, then at 220 each of the responses is stored, for example in memory 42. Accordingly, for each response, the match portion of the security binding is compared with the match portion of the security information from the responsive device at 222. As indicated, this comparison is also made at 222 for a single response received at 206. When the comparison at 222 is a success, that security binding is considered to be verified at that time.

When the comparison at 222 fails, it is considered a security violation. In such case, at 228 the network configuration is checked for security violations. At 230, if notifications are enabled, the network administrator will be notified of the security violation. At 232, if sticky bindings are not enabled, the number of responses received will be verified. If a single response is received, the entry in the security binding is replaced with the security information in the response at 234. If more than a single response is received, no additional action is taken at 236.

In one example, reactive polling is implemented in security table 47. With reactive polling, a specific host is polled when a conflict is detected for that host compared against white list 60. For example, a conflict occurs when the lookup matches a binding, but some portion of the bound information has a mismatch with the data packet. Source host B discussed above is an example that would trigger reactive polling. As mentioned, host B has security information of a MAC address that is 00bb00-bb00bb and an IP address that is 20.20.20.20. The lookup portion would find entry Y (based on MAC address of 00bb00-bb00bb for both), but reactive polling is triggered based on the conflict CPU 40 detected by the match portions failing (based on the host IP address of 20.20.20.20 and entry Y IP address of 40.40.40.40).

When such a conflict occurs, reactive polling stores the information (for example, frame, data packet, segment, etc.) in memory 42 from source host A and then polls the host using the information in the existing binding from white list 60. If the source host responded, then the stored information would be considered a security violation. If the host did not respond, then, depending on the configuration and the number of responses received, the information would be considered an update. The security binding in white list 60 in that case is changed to reflect the information. In the example above, entry Y is updated in white list 60 to have an IP address of 20.20.20.20.

Just as with proactive polling, the network administrator can also set controls on reactive polling. In addition to the same limitations discussed above for proactive polling, reactive polling is only triggered when the match portion of the security binding conflicts with the information from a host device, in one example. It will not be triggered when a lookup portion does not find an entry in white list 60. Reactive polling reduces CPU polling overhead relative to proactive polling since it is only triggered by certain events, rather than periodically done as with proactive polling. Reactive polling does incur a delay, however, between the conflict detection and a determination of the nature of the conflict.

For the examples given above, layer 2 and layer 3 addresses are used to illustrate sticky bindings, proactive polling and reactive polling, but any of a variety of OSI parameters can be used with sticky bindings, proactive polling and reactive polling. For example, layer 4 addresses or any of a variety of unique characteristics or addressing information by which host traffic is identified in any of the OSI layers 2-7 can be used to define the lookup portion and match portion of the bindings used with sticky bindings, proactive polling and reactive polling. Although these are illustrated in layer 2 devices, they can be resident in any of the layers of the OSI layers 2-7.

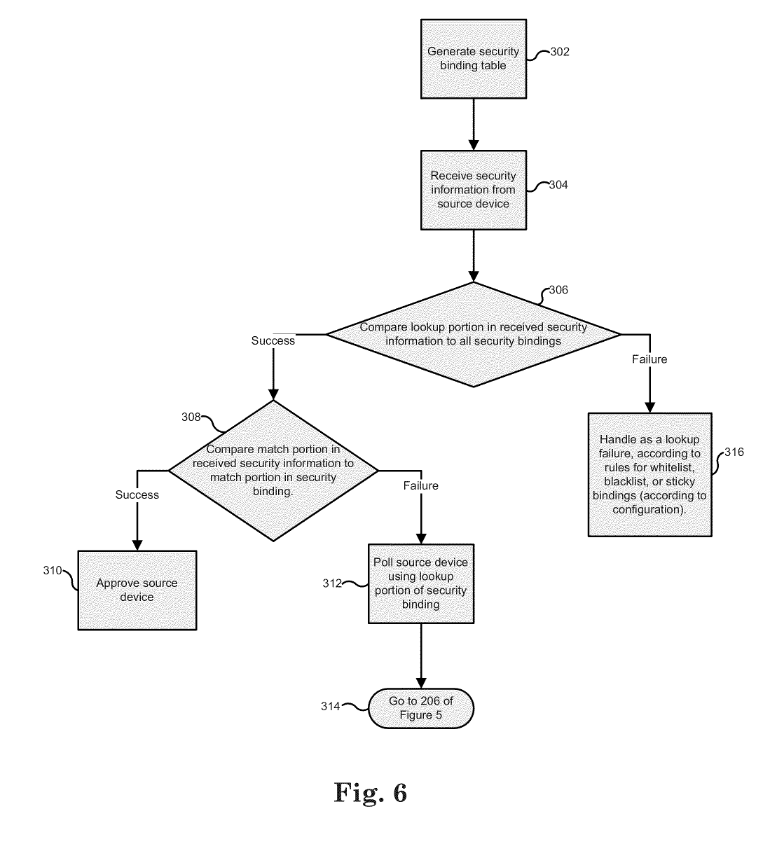

FIG. 6 is a flowchart illustrating one example of reactive polling. At 302, a security binding table is generated, for example, in a security table of a network device. In one example, each entry in the security binding table includes a lookup portion and match portion. At 304, security information, for example of a source device, is received. In one example, security information from the source device includes a lookup portion and match portion. At 306, the lookup portion of the security information from the source device is compared against the lookup portions of each entry in the security binding table. When the comparison of the lookup portions at 306 is successful, the corresponding match portions of the security information the security binding is compared at 308. When the comparison at 308 is successful, the source device is considered approved at 310.

When the comparison at 308 fails, a source device is polled using the lookup information of the entry in the security binding table at 312. At that point, the polling will be identical to the process detailed starting at item 206 of FIG. 5. Accordingly, at 314, the number of responses as a result of the polling is considered at 206. The remaining steps following step 206 will not be repeated here for brevity of description, but follow identically as previously described.

When the comparison of the lookup portions at 306 fails, this will be handled as a lookup failure according to the configurations in place, such as the rules in place for a white list, black list, or sticky bindings.

Although specific embodiments have been illustrated and described herein, it will be appreciated by those of ordinary skill in the art that a variety of alternate and/or equivalent implementations may be substituted for the specific embodiments shown and described without departing from the scope of the present invention. This application is intended to cover any adaptations or variations of the specific embodiments discussed herein. Therefore, it is intended that this invention be limited only by the claims and the equivalents thereof.

What is claimed is:

1. A network device comprising:
a security binding table having a plurality of entries each comprising a lookup potion and a match portion;
the network device configured to couple to a network and receive security information, which includes a lookup portion and a match portion, from a source device coupled to the network; and
a processor to:
compare the lookup portion of the received security information from the source device to the lookup portion of each entry of the security binding table and to compare the match portion of the received security information from the source device to the match portion of each entry of the security binding table to determine if there is a match; and
update the security binding table by adding an entry comprising the lookup portion and the match portion of the received security information from the source device when neither the lookup portion nor the match portion of the received security information from the source device matches any entry of the security binding table.

2. The network device of claim 1, wherein adding an entry in the security binding table occurs dynamically without direct intervention of a network administrator.

3. The network device of claim 1, wherein the security binding table is one of a white list and a black list resident in the network device.

4. The network device of claim 1, wherein the added entry in the security binding table is a sticky binding that can only be added during a time period that is set by a network administrator.

5. The network device of claim 1, wherein the added entry in the security binding table is a sticky binding, at least one of the lookup portion or the match portion comprises one of a group comprising a layer 2 address, layer 3 address, and layer 4 address.

6. The network device of claim 5, wherein sticky bindings are enabled only for a limited number of sticky bindings, a limited time period, a limited TCP/UDP protocol, a limited IP address range or set, only a certain ingress port or for any other combination of addressing characteristics from OSI layer 2-7.

7. A network device comprising:
a security binding table having a plurality of entries each comprising a lookup potion and a match portion; and
a processor to:
poll source devices using the lookup portion of entries in the security binding table to receive security information from the source devices, the security information having a lookup portion and a match portion;
compare the lookup portion of the security information of a polled source device to the lookup portion of an entry of the security binding table to determine if there is a match;
when a match is found between the lookup portion of the security information for the polled source device and the lookup portion of the entry of the security binding table, compare a corresponding match portion of the security information of the polled source device to a corresponding match portion the entry of the security binding table to determine if there is a match; and
dynamically update the entry of the security binding table when the match portion is not the same.

8. The network device of claim 7, wherein dynamically updating the entry in the security binding table occurs dynamically without direct intervention of a network administrator.

9. The network device of claim 7, wherein no dynamic updating of the entry of the security binding table is allowed where a match is found between the lookup portion of the security information for more than one source device and the lookup portion of the entry of the security binding table.

10. The network device of claim 7, wherein dynamically updating the entry of the security binding table is enabled only for limited source devices, for only a limited number of entries in the security binding table, only for a certain layer 3 address range or set, or only for a certain set of source ports.

11. The network device of claim 7, further comprising notifying a network administrator when no match is found between the match portion of the security information for any source device and the match portion of the entry of the security binding table.

12. The network device of claim 7, wherein for the dynamically updated entry in the security binding table, at least one of the lookup portion or the match portion comprises one of a group comprising a layer 2 address, layer 3 address, layer 4 address and addressing characteristics from OSI layer 2-7.

13. A method for providing security in a computer network, the method comprising:
generating a security binding table in a network device, the security binding table having a plurality of entries each comprising a lookup potion and a match portion;
receiving security information of a source network device, the security information having a lookup portion and a match portion;
comparing the lookup portion of the security information of the source network device to the lookup portion of each entry of the security binding table to determine if there is a match;
when a match is found between the lookup portion of the security information for the source network device and the lookup portion of the entry of the security binding table, comparing a corresponding match portion of the security information of the source network device to a corresponding match portion the entry of the security binding table to determine if there is a match;
polling a network device with the entry of the security binding table when the match portion of the security information of the source network device does not match the match portion of each entry of the security binding table; and
considering a security violation to have occurred when a response is received from the polled network device.

14. The method of claim 13 comprising considering the security binding stale when no response is received from the polled network device.

15. The method of claim 14 comprising dynamically updating the entry in the security binding table to the match portion of the security information of the source network device when no match is found with any other network devices.

16. The method of claim 15, wherein dynamically updating the entry in the security binding table occurs dynamically without direct intervention of a network administrator.

17. The method of claim 15, wherein no dynamic updating of the entry of the security binding table is allowed where a match is found between the lookup portion of the security information for more than one network device and the lookup portion of the entry of the security binding table.

18. The method of claim 15, wherein dynamically updating the entry of the security binding table is enabled only for limited network devices, for only a limited number of entries in the security binding table, only for a certain layer 3 address range or set, or only for a certain set of source ports.

19. The method of claim 15, wherein for the dynamically updated entry in the security binding table, at least one of the lookup portion or the match portion comprises one of a group comprising a layer 2 address, layer 3 address, layer 4 address and addressing characteristics from OSI layer 2-7.
